(19) United States
(12) Patent Application Publication
(10) Pub. No.: US 2007/0295840 A1
(43) Pub. Date: Dec. 27, 2007

(54) Fluidic oscillators and enclosures with split throats

(75) Inventors: Shridhar Gopalan, Westminster, MD (US); Gregory Russell, Catonsville, MD (US); Daniel Eugene Steerman, Harpers Ferry, WV (US)

Correspondence Address: LARRY J. GUFFEY, WORLD TRADE CENER - SUITE 1800, 401 EAST PRATT STREET, BALTIMORE, MD, 21202, US

(73) Assignee: Bowles Fluidics Corporation

(21) Appl. No.: 11/805,802

(22) Filed: May 24, 2007

Related U.S. Application Data
(63) Continuation-in-part of application No. 10/673,727, filed on Sep. 29, 2003, now Pat. No. 7,111,800.
(63) Continuation-in-part of application No. 11/245,396, filed on Oct. 6, 2005.
(60) Provisional application No. 60/808,173, filed on May 24, 2006.

(51) Int. Cl. F15C 1/22; B05B 1/02; F15C 1/16

(52) U.S. Cl. 239/589.1; 137/808

(57) ABSTRACT

An improved fluidic oscillator, that operates on a pressurized liquid flowing through the oscillator to generate a liquid jet that flows into the surrounding environment to form of an oscillating spray of liquid droplets, includes: a member into which is fabricated a two-portion, flow channel, with this first portion configured so as to create the flow phenomena in the member that yields the spray's oscillating nature, and wherein its second portion is configured so as to provide a plurality of throats by which the pressurized liquid exhausts into the surrounding environment.

### CROSS-REFERENCE TO RELATED APPLICATION

This application is a continuation-in-part of Assignee's U.S. Pat. No. 7,111,800, issued Sep. 26, 2006 and filed Sep. 29, 2003 and pending patent application U.S. Ser. No. 11/245,396, USPPN 2006-0108442, Attorney Docket No. BWLS29, filed Oct. 6, 2005. This application claims the benefit of Provisional Patent Application No. 60/808,173 filed May 24, 2006 by the present inventors. The teachings of these prior patent documents are incorporated herein by reference to the extent that they do not conflict with the teaching herein.

### BACKGROUND OF THE INVENTION

1. Field of the Invention

This invention relates to fluid handling processes and apparatus. More particularly, this invention relates to new methods and apparatus for enclosing fluidic oscillators or inserts so as to improve their performance.

2. Description of the Related Art

Fluidic inserts or oscillators are well known for their ability to provide a wide range of distinctive liquid sprays. The distinctiveness of these sprays is due to the fact that they are characterized by being oscillatory in nature, as compared to the relatively steady state flows that are emitted from standard spray nozzles.

FIG. 5 of the present Assignee's U.S. Pat. No. 4,052,002 illustrates the oscillatory nature of the spray from a typical fluidic oscillator. It shows what can be considered to be the essentially temporally varying, two-dimensional, planar flow pattern of a liquid jet or spray that issues from the oscillator into a surrounding gaseous environment and breaks into droplets which are distributed transversely to the jet's general direction of flow. Such spray patterns may be described by the definable characteristics of their droplets (e.g., the volume flow rate of the spray, the spray's area of coverage, the spatial distribution of droplets in planes perpendicular to the direction of flow of the spray and at various distances in front of the oscillator's outlet, the average droplet velocities, the average size of the droplets, and the frequency at which the droplets impact on an obstacle in the path of the spray).

A fluidic insert is generally thought of as a thin, rectangular member that is molded or fabricated from plastic and has an especially-designed, uniform depth, liquid flow channel fabricated into either its broader top or bottom surface, and sometimes both (assuming that this fluidic insert is of the standard type that is to be inserted into the cavity of a housing whose inner walls are configured to form a liquid-tight seal around the insert and form an outside wall for the insert's boundary surface/s which contain the especially designed flow channels). Pressurized liquid enters such an insert and is sprayed from it. See, for example the fluidic insert (18) and housing (10) in FIG. 1 of the present Assignee's U.S. Pat. No. 7,014,131.

Although it is more practical from a manufacturing standpoint to construct these inserts as thin rectangular members with flow channels in their top or bottom surfaces, it should be recognized that they can be constructed so that their liquid flow channels are placed practically anywhere (e.g., on a plane that passes though the member's center) within the member's body; in such instances the insert would have a clearly defined channel inlet and outlet. For example, see the present Assignee's U.S. Pat. No. 5,820,034 which shows a two-part (50a, 50b), fluidic insert whose exterior surface is cylindrical so that this insert can be fitted into a similarly shaped housing (72).

Additionally, it is know that such fluidic inserts may be formed by using projections that extend from a base plate so as to form essentially the central part of a fluid circuit that does not have any sidewalls. The sidewalls for the flow through such inserts are formed by the boundary walls of the enclosing housing. See FIG. 2C of the present Assignee's U.S. Patent Publication No. 2006-0226266. The advantage of a fluidic insert constructed in this manner is that the overall width of the insert and its housing can be reduced, which can be important for various spraying applications (e.g., windshield washer applications) which impose geometric restrictions on allowable insert widths.

Regarding such fluidic inserts, it is also known that their flow channels need not be of a uniform depth. For example, see the present Assignee's U.S. Pat. No. 4,463,904, U.S. Pat. No. 4,645,126 and RE38,013 for fluidic oscillators in which the bottom surfaces of these channels are discretely and uniformly sloped so as to impact the ways in which the sprays from these oscillators spread as the move away from the oscillator's outlet.

There are many well known designs of fluidic circuits that are suitable for use with such fluidic inserts. Many of these have some common features, including: (a) at least one power nozzle configured to greatly accelerate the movement of the liquid that flows under pressure through the insert so that it separates from the walls downstream of the power nozzle so as to form an essentially “free” jet downstream of the power nozzle, (b) an interaction chamber through which the liquid flows and in which the flow phenomena is initiated that will eventually lead to the spray from the insert being of an oscillating nature, (c) an liquid inlet, (d) a pathway that connects the inlet and the power nozzle/s, and (e) an outlet or throat from which the liquid sprays from the insert.

Examples of fluidic circuits may be found in many patents, including the present Assignee's U.S. Pat. No. 3,563,462 (Bauer), U.S. Pat. No. 4,052,002 (Stouffer & Bray), U.S. Pat. No. 4,151,955 (Stouffer), U.S. Pat. No. 4,157,161 (Bauer), U.S. Pat. No. 4,231,519 (Stouffer), which was reissued as RE 33,158, U.S. Pat. No. 4,508,267 (Stouffer), U.S. Pat. No. 5,035,361 (Stouffer), U.S. Pat. No. 5,213,269 (Srinath), U.S. Pat. No. 5,971,301 (Stouffer), U.S. Pat. No. 6,186,409 (Srinath) and U.S. Pat. No. 6,253,782 (Raghu).

Despite much prior art relating to the development of fluidic circuits, the nature of the housings or enclosures that surround fluidic oscillators have changed only slowly over the years. For example, the overall exterior shape of a fluidic oscillator's automotive windshield washer is invariably aerodynamically configured from its rear to its front face in consideration of the fact that this housing will be mounted on an automobile's hood and in front of its windshield.

FIG. 2 of U.S. Pat. No. 6,062,491 shows a more recent housing design that is notable for its having two cavities into which cooperating fluidic oscillators are inserted. As an alternative to such configurations, it can be noted that it is also known to place more than one fluidic circuit on the same insert, see the “double spray” insert or oscillator of the present Assignee's U.S. Pat. No. 7,014,131.

Housings for fluidic inserts have also been designed for specific applications. For example, see FIGS. 5 and 8C of the present Assignee's USPPN 2004-0227021 which show a housing whose exterior surface has been especially configured to allow this housing and its enclosed fluidic oscillator to be used as part of a “quick disconnect” nozzle assembly.

For an example of a housing that is suitable for showerhead applications, see FIG. 15A of the present Assignee's U.S. Pat. No. 7,111,800. Shown there is a housing which also has an exterior surface that has been especially configured to allow this housing to be used as part of a specialized nozzle assembly (i.e., a showerhead). It also has a cavity that is especially configured to accept a stack of fluidic oscillators in which the centerlines of the adjoining oscillators have a specified, included angle of divergence.

While one generally thinks of the enclosures for these inserts or oscillators as being of an almost totally enclosing nature (in which case, we herein refer to them as housings), this need not be the case. FIG. 3 of the present Assignee's U.S. Pat. No. 5,845,845 shows a “lid” (32) for enclosing only the boundary surface of the oscillator in which the fluidic circuit is located. Note that its knobs (45, 46) are for securing the lid and are not part of the fluidic circuit.

One common feature that may not have been noticed in examining the early versions of the housings previously mentioned is that they all provide for what is called “frontal entry” or loading of the fluidic insert into the housing. More recently, it was discovered that there are advantages to sometimes designing these housings so that they provide for “rear entry” of the fluidic inserts into the housings. See FIGS. 7-8 and 10 of present Assignee's USPPN 2006-0108442.

The FIGS. 7A-7D of USPPN 2006-0108442 show various views of an enclosure or housing that has both a rear surface, with an opening which allows for the rear loading of a fluidic oscillator, and a front surface which has a portion that is configured so as to provide a throat for the fluid that flows from the fluidic oscillator. These types of housings are notable for, among other things, being the first of their type that have an element of the fluidic circuit (e.g., a throat) fabricated into the front face of the housing.

Previously and with “front entry” housings, all of the elements of a fluidic circuit were, out of necessity, always molded directed into the fluidic insert—the front face of the fluidic insert was the most downstream point of the passage from which the fluid spray issued.

The FIGS. 8A-8C of USPPN 2006-0108442 show views of the front faces of various “showerhead” enclosures that have been fabricated with many especially oriented and configured cavities in a single housing. A key advantage of such enclosures is that they provide the opportunity to use various unique arrays of fluidic oscillators to create a combined spray whose droplet flow characteristics are unique in comparison to those sprays that could be produced by any other known means.

The FIG. 10 of USPPN 2006-0108442 shows the front face of a multi-cavity “showerhead” enclosure that allows for a multiple mode of spray operation. The perimeter of this housing has a ring of conventional orifices that emit a conventional, non-oscillating jet spray intended primarily for rinsing purposes. Within this ring there exists an octagonal array of eight fluidic-oscillator-containing passages and at the center of this face is a triangular array of three fluidic-oscillator-containing passages.

The enclosures for fluidic oscillators can also be of a two-part construction (i.e., using a secondary housing which is then inserted in a specified manner into a primary housing). This proves to be especially useful in those instances in which it is desired to make the enclosures such that they allow one to adjust the direction of the spray that flow from the oscillator. The FIGS. 3A-3B and 4A-4B of the present Assignee's USPPN 2006-0226266 shows such an adjustable spray nozzle with its secondary (30) and primary (50) housings.

As fluidic oscillators have continued to be used in more types of applications, the opportunity has arisen to re-examine and improve upon the design of their housings or enclosures as a way to improve upon the overall spraying performance of the nozzle assemblies, etc. which use fluidic oscillators.

### OBJECTS AND ADVANTAGES

There has been summarized above, rather broadly, the prior art that is related to the present invention in order that the context of the present invention may be better understood and appreciated. In this regard, it is instructive to also consider the objects and advantages of the present invention.

It is an object of the present invention to provide an assortment of individual housings or enclosures for fluidic inserts or oscillators that can be helpful in improving upon the actual spray performance of the spray devices or nozzle assemblies that utilize fluidic oscillators.

It is an object of the present invention to provide fluidic spray assemblies (i.e., fluidic oscillators with novel enclosures) that can provide specific types of desired sprays that have heretofore not been achievable with conventional fluidic technology.

It is an object of the present invention to provide improved and more versatile fluidic inserts and their enclosures which are ideally designed for a wide range of windshield washer applications.

It is an object of the present invention to provide improved enclosures and fluidic inserts that are ideally designed for an assortment of commercial cleaning applications.

It is an object of the present invention to provide enclosures and fluidic inserts that allow a user to better direct and control the location of the areas being wetted by the sprays from such devices.

These and other objects and advantages of the present invention will become readily apparent as the invention is better understood by reference to the accompanying summary, drawings and the detailed description that follows.

### SUMMARY OF THE INVENTION

Recognizing the need for the development of improved fluidic oscillators and their enclosures, the present invention is generally directed to satisfying the needs set forth above and overcoming the limitations seen in the prior art devices and methods.

In accordance with the present invention, an improved fluidic oscillator, of the type that operates on a pressurized liquid flowing through it to generate an oscillating spray of liquid droplets, includes a member into which is fabricated a two-portion, flow channel, with this first portion configured so as to create the flow phenomena in the member that yields the spray's oscillating nature, and wherein its second portion is configured so as to provide a plurality of throats by which the pressurized liquid exhausts into the surrounding environment.

In a second preferred embodiment, the present invention takes the form of an enclosure for a fluidic oscillator and includes a body having interior and exterior surfaces, with a portion of the body's interior surface configured to attach to the oscillator's boundary surface which contains its fluidic circuitry so as to form an enclosed pathway through which the liquid may flow, and wherein a portion of the body's interior surface is configured so as to provide a plurality of throats through which the pressurized liquid may exhaust.

Thus, there has been summarized above, rather broadly and understanding that there are other preferred embodiments which have not been summarized above, the present invention in order that the detailed description that follows may be better understood and appreciated. There are, of course, additional features of the invention that will be described hereinafter and which will form the subject matter of the later presented claims to this invention.

### BRIEF DESCRIPTION OF THE DRAWINGS

FIG. 1A-1B show a preferred embodiment of the present invention in the form of a housing which has an especially configured front wall or face into which are molded a three-part throat followed by separate expansion passages and exits (i.e., a single upper and two lower throats, etc.) which provide multiple spray outputs from the housing's front portion or face.

FIG. 2 gives an indication of the nature of the sprays from the embodiment shown in FIG. 1.

FIGS. 3A-3C show a preferred embodiment of the present invention in the form of a fluidic insert which has an especially configured front wall or face into which are molded a three-part throat followed by separate expansion passages and exits (i.e., a single upper and two lower throats, etc.) which provide multiple spray outputs from the insert's front portion or face.

FIG. 4 shows a preferred embodiment with a dual throat that is formed by a vertical cylinder intersecting what would otherwise be a single, wide throat.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

A common problem encountered in developing and producing fluidic oscillators or inserts for use in automotive windshield applications is designing a fluidic circuit which can give the desired spray characteristics (e.g., at flow rates of 400 ml/minute and operating pressures of 9 psig, uniform coverage with spray droplets of a target area located approximately 25 cm in front of the sprayer and having a target area width of approximately 80 cm) and which can be fitted into a housing which is very limited on its allowable size. Because such housings often are situated in locations on an automobile's hood that are quite visible, their allowable dimensions are often dictated by aesthetic considerations (e.g., typical acceptable widths are on the order of 10-12 mm). The consequence of this is that the spray from the windshield washers situated in such housings must have, what is referred to as, a large horizontal fan angle, φ (i.e., defined by the lateral or horizontal boundaries of the region wetted by the spray).

Since such inserts and their enclosures are typically made by plastic injection molding methods, those knowledgeable with such manufacturing methods will understand that such manufacturing methods impose further constraints on the geometry of such inserts and their enclosures. For example, a 12 mm wide housing can only accommodate a fluidic insert having a maximum width of about 9 mm since the wall thickness of such housings must typically be about 1 mm or larger.

In striving to improve the performance of various types of fluidic sprayers, we have discovered that there are significant opportunities to create and introduce new enclosures for these fluidic oscillators that appreciably improve their performance. We have also found that still further novel designs can be provided for a generalized fluidic oscillator which can increase its performance

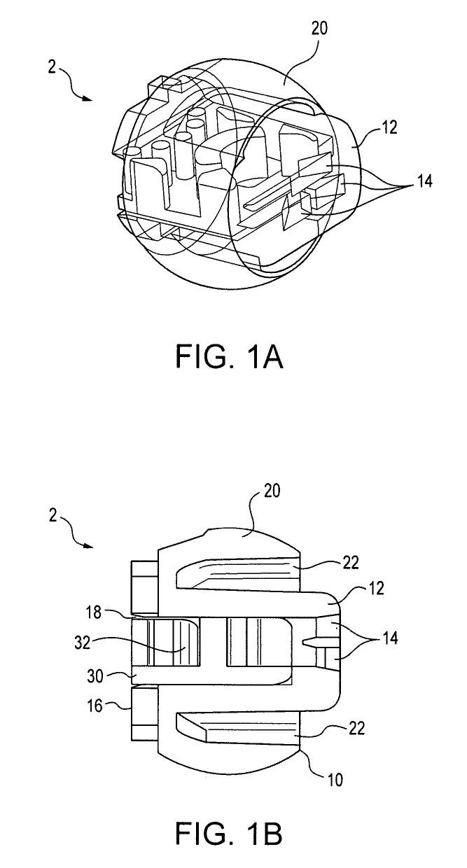

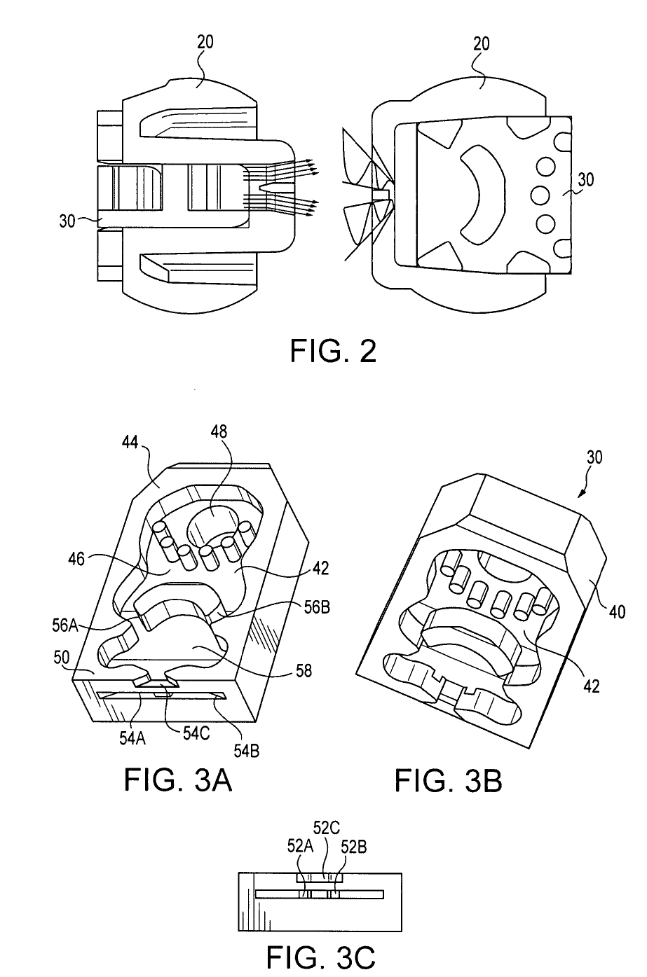

A preferred embodiment of the present invention 2 takes the form of a housing 10 which has a front portion 12 into which has been molded one or more elements 14 of the fluidic circuit 32 which is inscribed or molded into the fluidic insert 30 that is inserted into the housing from an opening 18 that exists in its rear face 16. See FIGS. 1A-1B which show an embodiment in which this fluidic circuit element is a three-part throat followed by separate expansion passages and exits (i.e., a single upper and two lower throats, etc.) which provide multiple spray outputs from the housings front portion or face. An indication of the nature of the sprays from this embodiment of the present invention is shown in FIG. 2.

A word needs to be mentioned regarding the novelty of this embodiment. For those knowledgeable in the design of fluid nozzles and advanced fluid dynamic principles, it should be noted that it was not an obvious matter that the situation shown here, in which multiple throats are fed by a single, relatively larger scaled fluidic circuit, would actually yield oscillating flows from each of the downstream throats. The fluid flow is these passages is very complicated and is not amenable to a theoretical solution; thus, extensive experiments had to be conducted to better understand these types of flows. It was only as a result of these experiments that it was discovered that the flow geometry shown in FIG. 1 would actually produce the desired oscillating flows from each of the multiple throats.

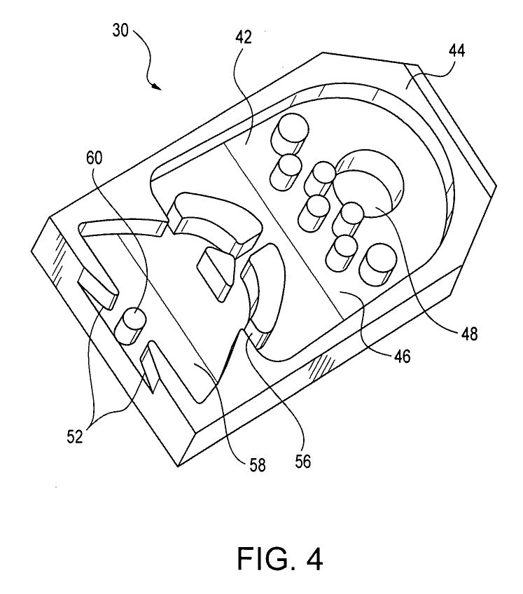

It can be seen in FIGS. 1A-1B that this embodiment has an outer surface which has a portion 20 that is spherically shaped. This housing is configured as such so that it can be used as the secondary housing which is inserted into the primary housing, previously referenced in FIG. 3A-3B of the present Assignee's USPPN 2006-0226266, so as to yield an adjustable nozzle. The slots 22 in this housing's front face are used to receive the prong/s of a tool that is used to adjust the orientation angle and direction of the sprays that flow from the housing.

A second preferred embodiment of the present invention is the fluidic insert or oscillator 4 shown in FIG. 3 and which is seen to be an improvement of the generalized “front loaded” fluidic insert that was previously referenced as being shown in FIG. 1 of the present Assignee's U.S. Pat. No. 7,014,131.

FIG. 3 shows as a rectangular member 40 that is molded or fabricated from plastic and has an especially-designed liquid flow channel or fluidic circuit 42 fabricated into, in this instance, a first portion of its broader top surface 44 (i.e., it could have been its bottom or side or some combination of these) and into which liquid flows from an inlet 48 in the insert's floor 46. This fluidic insert is of the type that is to be inserted into the cavity of a housing whose inner walls are configured to form a liquid-tight seal around the sidewalls of the insert.

This insert is seen to have a second portion with a novel front wall 50 into which are molded multiple throats: two lower throats 52A, 52B with their adjoining, downstream expansion passages 54A, 54B and a single upper throat 52C and its downstream expansion passage 54C. Pressurized liquid enters this insert and oscillating liquid sprays issue from each of its three throats.

In this embodiment, the upstream elements of the fluidic circuit shown in FIG. 3 are two especially configured and cooperating power nozzles 56A, 56B that direct flow into an especially configured interaction chamber 58. However, other fluidic circuits have been found to be equally satisfactory at yielding separate oscillating sprays from multiple throats that have been placed in a front wall that forms the downstream boundary for the oscillator's interaction chamber. These other fluidic circuits are, by previous references, considered to come within the scope of the disclosure of the present invention.

A third preferred embodiment of the present invention that is similar to that shown in FIG. 3 is shown in FIG. 4. It is a generalized “front loaded” fluidic insert with fluidic circuit 42 fabricated into its broader top surface 44. Its front end has a dual throat 52 that is formed with a vertical cylinder 60 that intersects what would otherwise be a single wider throat.

It can be noted that the present invention was discovered and created as a result of the continuing pressures to minimize the size of the fluidic spray devices for a wide range of applications, including those for windshield washers. The herein disclosed split or multiple throat housings are seen to allow for the use of only a single fluidic insert, with its advantageous larger flow passages, to be used with such housings.

The advantages of using a single insert or oscillator, over the multiple inserts, previously referenced as being shown in U.S. Pat. No. 6,062,491, U.S. Pat. No. 7,111,800 and USPPN 2006-0108442, to achieve the same spray coverage have been experimentally found to be: (a) better high viscosity or low temperature operating performance, (b) less chance of insert clogging, (c) higher possible flow rates for a given size or space restriction, and (d) higher potential exit velocities.

The prior state of the art for better spray distribution from automotive windshield washer devices often involved the use of “double spray” inserts or nozzles (i.e., two fluidic circuits on one insert, with the bottom circuit distributing fluid over a wide pattern toward the lower portion of the windshield and the top circuit distributing the spray over a smaller pattern toward the upper portion of the windshield).

The limits of available fluid flow and pressure on automotive vehicles often required that each of these circuits have smaller dimensions than those of the single circuit devices which they were replacing. However, this type of configuration presented performance problems since such smaller oscillators cannot perform as well as larger oscillators in higher viscosity fluids, such as cold washer fluid.

An advantage of the present invention is that it allows for the use of a larger dimensioned insert or oscillator (e.g., such as would be used in a single spray application) to distribute fluid like the smaller oscillators used in the double insert housings that were previously referenced in U.S. Pat. No. 6,062,491. The larger dimensioned inserts of the present invention offer significantly improved spray patterns.

The foregoing is considered as illustrative only of the principles of the invention. Accordingly, all suitable modifications and equivalents of the present disclosure may be resorted to and still considered to fall within the scope of the invention as hereinafter set forth in claims to the present invention.

We claim:

1. An enclosure for a fluidic oscillator that operates on a pressurized liquid flowing through said oscillator to generate a liquid jet that flows from said oscillator and into a surrounding environment to form an oscillating spray of liquid droplets, said oscillator having a boundary surface having fabricated therein a channel in the form of a fluidic circuit whose geometry is configured so as to aid in establishing the oscillating nature of said spray of liquid droplets, said enclosure comprising:
a body having an interior and an exterior surface,
wherein a first portion of said interior surface configured to attach to said oscillator boundary surface so as to form with said channel an enclosed pathway through which said liquid may flow, and
wherein a second portion of said interior surface configured so as to provide a plurality of throats thought which said pressurized liquid may exhaust.

2. The enclosure as recited in claim 1, wherein:
said body configured as a housing,
with said exterior surface including:
a front and a rear face and an intermediate boundary surface that connects said faces,
and said interior surface including:
a passage that extends between said faces, with said passage having a front and a rear section,
said passage rear section forming a cavity having an opening in said body rear face and said cavity configured to allow for the insertion of said fluidic oscillator into said cavity,
said passage front section configured so as to include said plurality of throats.

3. A method of forming an enclosure for a fluidic oscillator that operates on a pressurized liquid flowing through said oscillator to generate a liquid jet that flows from said oscillator and into a surrounding environment to form an oscillating spray of liquid droplets, said oscillator of the type having a boundary surface having fabricated therein a channel in the form of a fluidic circuit whose geometry is configured so as to aid in establishing the oscillating nature of said spray of liquid droplets, said method comprising the steps of:
utilizing a body having an interior and an exterior surface,
configuring a first portion of said interior surface to attach to said oscillator boundary surface so as to form with said channel an enclosed pathway through which said liquid may flow, and
configuring a second portion of said interior surface so as to provide a plurality of throats thought which said pressurized liquid may exhaust.

4. The method as recited in claim 3, furthering including the steps of:
configuring said body as a housing,
with said exterior surface including:
a front and a rear face and an intermediate boundary surface that connects said faces,
and said interior surface including:
a passage that extends between said faces, with said passage having a front and a rear section,
configuring said passage rear section to have a cavity with an opening in said body rear face and configured to allow for the insertion of said fluidic oscillator into said cavity,
configuring said passage front section so as to include said plurality of throats.

5. A fluidic oscillator that operates on a pressurized liquid flowing through said oscillator to generate a liquid jet that flows from said oscillator and into a surrounding environment in the form of an oscillating spray of liquid droplets, said oscillator comprising:
a member,
a channel fabricated in said member and through which said pressurized liquid flows, said channel having a first and a second portion,
wherein said channel first portion configured so as to create the flow phenomena in said member that yields said oscillating nature of said spray,
wherein said channel second portion configured so as to provide a plurality of throats by which said pressurized liquid exhausts into said surrounding environment.

6. The fluidic oscillator as recited in claim 5, wherein:
said member having a boundary surface into which said channel is fabricated.

7. A method of forming a fluidic oscillator of the type that operates on a pressurized liquid flowing through said oscillator to generate in the surrounding environment an oscillating spray of liquid droplets, said method comprising the steps of:
utilizing a member,
fabricating a channel in said member and through which said pressurized liquid flows, said channel having a first and a second portion,
configuring said channel first portion so as to create the flow phenomena in said member that yields said oscillating nature of said spray,
configuring said channel second portion so as to provide a plurality of throats by which said pressurized liquid exhausts into said surrounding environment.

8. The method as recited in claim 7, further comprising the steps of:
providing said member with a boundary surface into which said channel is fabricated.
